(19) United States
(12) Patent Application Publication
(10) Pub. No.: US 2026/0036725 A1
(43) Pub. Date: Feb. 5, 2026

(54) DISPLAY MODULE AND DISPLAY DEVICE

(71) Applicants: Wuhan Tianma MicroElectronics Co., Ltd. Shanghai Branch., Shanghai (CN); Wuhan Tianma Micro-Electronics Co., Ltd., Wuhan (CN)

(72) Inventor: Mingzhe LV, Shanghai (CN)

(21) Appl. No.: 18/984,618

(22) Filed: Dec. 17, 2024

(30) Foreign Application Priority Data
Jul. 30, 2024 (CN) 202411038167.7

(51) Int. Cl. G02B 5/00; G06F 3/041

(52) U.S. Cl. CPC G02B 5/003; G06F 3/0412

(57) ABSTRACT

A display module and a display device are provided. The display module includes a display panel; a polarizing component; and an absorption layer disposed between the display panel and the polarizing component. The absorption layer includes a combination of a matrix resin and a porous absorption material.

### CROSS-REFERENCE TO RELATED APPLICATION

This application claims the priority of Chinese Patent Application No. 202411038167.7, filed on Jul. 30, 2024, the content of which is incorporated by reference in its entirety.

### TECHNICAL FIELD

The present disclosure generally relates to the field of display technologies and, more particularly, relates to a display module and a display device.

### BACKGROUND

In recent years, to meet the diverse display needs, display devices with different functions have emerged. Intelligence, portability and flexibility are the development directions of display devices. Flexible display devices break the traditional two-dimensional display concept; and they can be folded and bent as needed to reduce the size, increase the screen-to-body ratio and improve the user's visual experience. Recently, flexible display devices have gradually become mainstream products in the display field.

A display device usually includes a panel and a polarizer located on the light-exiting side of the panel. Existing polarizers are prone to failure problems. Especially under elevated temperature and high humidity conditions, polarizer failure and fading will not only cause abnormal display effects, but also make the touch performance of the product worse, and the touch sensitivity will be reduced or even the touch will fail. Such failure problems are particularly serious in flexible display devices, which seriously affect the display effect and product yield of the device.

Therefore, how to avoid the poor display and touch problems caused by the failure of polarizers and provide higher quality display devices is the research focus of this field. The present disclosed display modules and display devices are direct to solve such a problem and other problems in the art.

### SUMMARY

One aspect of the present disclosure provides a display module. The display module includes a display panel; a polarizing component; and an absorption layer disposed between the display panel and the polarizing component. The absorption layer includes a combination of a matrix resin and a porous absorption material.

Another aspect of the present disclosure includes a display device. The display device includes a display module. The display module includes a display panel; a polarizing component; and an absorption layer disposed between the display panel and the polarizing component. The absorption layer includes a combination of a matrix resin and a porous absorption material.

Other aspects of the present disclosure can be understood by those skilled in the art in light of the description, the claims, and the drawings of the present disclosure.

### BRIEF DESCRIPTION OF THE DRAWINGS

To illustrate the technical solutions in the embodiments of the present disclosure more clearly, the following briefly introduces the accompanying drawings used in the description of the embodiments. Obviously, the accompanying drawings in the following description are only some embodiments of the present disclosure, for those of ordinary skill in the art, other drawings can also be obtained from these drawings without creative effort.

FIG. 1 illustrates an exemplary display module in research;

FIG. 2 illustrates an exemplary display module according to various disclosed embodiments of the present disclosure;

FIG. 3 illustrates another exemplary display module according to various disclosed embodiments of the present disclosure;

FIG. 4 illustrates another exemplary display module according to various disclosed embodiments of the present disclosure; and

FIG. 5 illustrates a top view of an exemplary display module according to various disclosed embodiments of the present disclosure.

### DETAILED DESCRIPTION

The technical solution of the present disclosure is further explained below through specific implementation methods. Those skilled in the art should understand that the embodiments are only to help understand the present disclosure and should not be regarded as specific limitations of the present disclosure.

In the present disclosure, the terms “upper”, “lower”, “inner”, “outer”, “vertical”, and “horizontal”, etc., indicate the orientation or position relationship based on the orientation or position relationship shown in the drawings, which is only for the convenience of describing the present disclosure and simplifying the description, rather than indicating or implying that the device or element referred to must have a specific orientation, be constructed and operated in a specific orientation, and cannot be understood as a limitation of the present disclosure.

In the present disclosure, unless otherwise clearly specified and limited, the terms “connected”, “bonded”, “installed”, or “fixed”, etc., should be understood in a broad sense, for example, it may be a fixed connection, a detachable connection, or an integral one; it may be a mechanical connection or an electrical connection; it may be a direct connection or an indirect connection through an intermediate medium; or it may be the internal connection of two elements or the interaction relationship between two elements. For ordinary technicians in this field, the above-mentioned specific meanings in the present disclosure can be understood according to the specific circumstances.

It has been known that a display device usually includes a display panel and a polarizer located on the light-exiting side of the display panel. Under elevated temperature and high humidity conditions, the polarizer is highly likely to fail and fade, which not only leads to abnormal display effects, but also deteriorates the touch performance of the product, resulting in reduced touch sensitivity or even touch failure. Such failure problems are particularly obvious in foldable flexible display devices, which seriously affect the touch display effect and product yield of the display device.

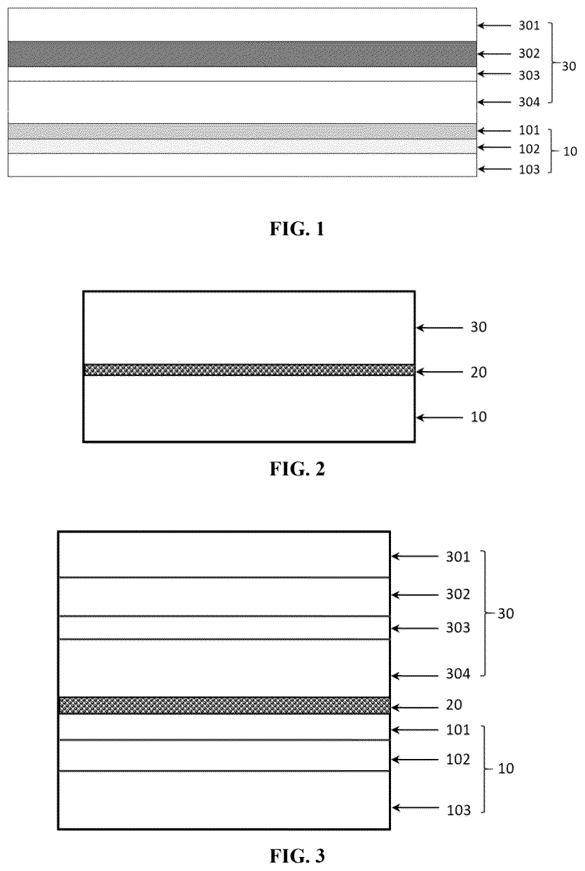

FIG. 1 is a structural schematic diagram of a display device in a research process. As shown in FIG. 1, the display device includes a display panel 10 and a polarizing component 30. The display panel 10 includes a touch layer 101, an encapsulation layer 102 and a light-emitting layer 103 arranged in sequence, and the touch layer 101 is located on a side of the display panel adjacent to the polarizing component 30. The polarizing component 30 includes a protective layer 301, a linear polarization layer 302, a wave plate layer 303 and an adhesive layer 304 arranged in sequence, and the adhesive layer 304 is located on a side of the polarizing component 30 adjacent to the display panel 10. The current mainstream material of the linear polarization layer 302 is iodine-based PVA, which is a PVA (polyvinyl alcohol) material containing polyiodine compounds (including I³⁻ and I⁵⁻) to achieve polarization. It has been found that in an elevated temperature and high humidity environment, polyiodine compounds are easily affected by water vapor, causing the content ratio of I³⁻ and I⁵⁻ to change, resulting in a change in the hue of the polarizing component, affecting the display effect. At the same time, polyiodine compounds react with water, and the formed I₂ or I⁻ is easy to diffuse to the surroundings, especially to the touch layer 101 and react with the metal and other materials therein, causing corrosion of the touch layer and failure of related touch functions. In addition, the encapsulation layer 102 releases NH₃ and the like at elevated temperatures. The escape of NH₃ accelerates the decomposition and content change of polyiodine compounds in the linear polarization layer 302, aggravates the generation of I₂ and I⁻, and is accompanied by corrosion of the touch layer 101, further aggravating the deterioration of the display effect and touch function, thereby resulting in poor display of the display device, accompanied by the failure of the touch function, and reduced product yield and quality.

The present disclosure provides a display module and a display device including the display module. An absorption layer may be disposed between the display panel and the polarizing component, the absorption layer may contain a matrix resin and a porous absorption material, which may block the intrusion of water vapor, avoid the adverse effects of water vapor on the polarizing component (especially the linear polarization layer), and fully absorb various gases escaping from the polarizing component (linear polarization layer) and the display panel (encapsulation layer) under high temperature and high humidity conditions, prevent the gas from corroding and damaging the internal structure of the display panel and the polarizing component, reduce or avoid the failure risk of the polarizer, especially effectively reduce the corrosion of the metal layer that begins at the edge of the display module under high temperature and high humidity conditions, and overcome the defects of poor display and poor touch caused by the failure of the polarizer. Accordingly, the display module and the display device may have better display and touch effects, the product quality and yield may be improved, and the above technical problems may be solved.

To make the above purposes, features and effects of the present disclosure more obvious, the present disclosure is further described in detail below in conjunction with the accompanying drawings and specific embodiments. It should be noted that the drawings of the present disclosure may not be drawn according to the actual scale.

FIG. 2 is a partial structural schematic diagram of an exemplary display module according to various embodiments of the present disclosure. As shown in FIG. 2, the display module may include a display panel 10, an absorption layer 20 and a polarizing component 30. The absorption layer 20 may be disposed between the display panel 10 and the polarizing component 30. The absorption layer 20 may be made of a combination of a matrix resin and a porous absorption material.

In the display module of the present disclosure, the absorption layer 20 between the display panel 10 and the polarizing component 30 may include a porous absorption material, which may give it an excellent gas adsorption function. On the one hand, the absorption layer 20 may effectively block the invasion of water vapor, reduce or avoid the adverse effects of water vapor on the polarizing component 30 and the display panel 10; on the other hand, the absorption layer 20 may fully absorb a variety of gases escaping from the polarizing component 30 and the display panel 10 under conditions of high temperature and high humidity, and prevent the gas from corroding and damaging the internal structure of the display module, thereby reducing or avoiding the risk of failure of the polarizing component, solving the problems of poor display and poor touch caused by the failure of the polarizing component, and making the display module have better display and touch effects, and improving product quality and yield.

In some embodiments of the present disclosure, the display panel may include a light-emitting layer, a touch layer, and an encapsulation layer disposed between the light-emitting layer and the touch layer. The touch layer may be located on a side of the display panel adjacent to the polarizing component.

In some other embodiments of the present disclosure, the polarizing component may include an adhesive layer, a wave plate layer, a linear polarization layer, and a protective layer disposed in sequence. The adhesive layer may be located on a side of the polarizing component adjacent to the display panel.

FIG. 3 is a partial structural schematic diagram of an exemplary display module according to various embodiments of the present disclosure. As shown in FIG. 3, the display module may include a display panel 10, an absorption layer 20, and a polarizing component 30. The display panel 10 may include a touch layer 101, an encapsulation layer 102, and a light-emitting layer 103 disposed in sequence. The touch layer 101 may be located on a side of the display panel 10 adjacent to the polarizing component 30. The polarizing component 30 may include a protective layer 301, a linear polarization layer 302, a wave plate layer 303, and an adhesive layer 304 disposed in sequence. The adhesive layer 304 may be located on a side of the polarization component 30 adjacent to the display panel 10. In some optional embodiments of the present disclosure, the touch layer 101 may include a metal touch layer.

It should be noted that the present disclosure does not specifically limit the structure and material of the metal touch layer, and the metal touch layers that can be used for display modules known in the art are applicable to the present disclosure. Metal materials may have excellent conductivity, but their light transmittance may be relatively low. As an optional implementation, the metal touch layer may include a metal grid unit. In some embodiments, a metal grid unit may be formed by crossing metal wires to have better transmittance to avoid the metal touch layer from affecting the light-emitting effect, and to have the characteristics of low impedance and flexibility.

In one embodiment, the material of the metal touch layer may be any one of Ti, Al, Cu, Mo, Ag, or a combination of at least two. The combination may include but is not limited to: Ti/Al/Ti, or Mo/Al/Mo.

In some embodiments of the present disclosure, the encapsulation layer 102 may include silicon nitride and/or silicon oxide. In some embodiments of the present disclosure, the linear polarization layer 302 may be an iodine-based polarizer.

Because the linear polarization layer 302 may be an iodine-based polarizer, the material may be iodine-based PVA, which contains polyiodine compounds (including I³⁻ and I⁵⁻) and PVA (polyvinyl alcohol), in a high temperature and high humidity environment, the polyiodine compounds may react with water, and the formed I₂ or I⁻ may easily diffuse to the surroundings. I₂ or I⁻ may react with the metal (such as Al) in the metal touch layer in the presence of water, causing corrosion and failure of related touch functions. Further, the encapsulation layer 102 may release NH₃ at elevated temperatures, accelerating the decomposition of polyiodine compounds and the generation of I₂ and I⁻, thereby aggravating the corrosion of the metal touch layer. The display module of the present disclosure may be provided with an absorption layer, which may effectively block the invasion of water vapor, absorb I₂ generated by the linear polarization layer 302 and NH₃ generated by the encapsulation layer 102 in a high temperature and high humidity environment, thereby reducing or avoiding the failure risk of the polarization component, preventing the gas from corroding the metal touch layer, and especially effectively reducing the corrosion of the metal touch layer that begins at the edge of high temperature and high humidity, and avoiding touch failure. Accordingly, the display module may have better display and touch effects.

It should be noted that the present disclosure does not specifically limit the light-emitting layer 103, and the light-emitting layers that can be used for display modules known in the art may be applicable to the present disclosure. The light-emitting layer 103 may include multiple pixels according to display requirements to display image information. The multiple pixels may be of the same color, or may include two colors, three colors or more than three colors.

The present disclosure does not specifically limit the protective layer 301, the wave plate layer 303 and the adhesive layer 304 in the polarizing component 30, and the protective layer, the wave plate layer and the adhesive layer that can be used for polarizing components (polarizers) known in the art may be applicable to the present disclosure. Exemplarily, the protective layer may include triacetyl cellulose (TAC), which may have high light transmittance, and good water resistance and mechanical strength, and may provide protection for the linear polarization layer 302. The wave plate layer may include quartz or other transparent materials, which may play a role in controlling the polarization state of the light beam. The adhesive layer may include optical adhesive (OCA).

In some embodiments of the present disclosure, the porous absorption material may include any one of molecular sieves, activated carbon, organic conjugated materials containing acidic groups, and metal organic framework materials, or a combination of at least two of them.

In the present disclosure, the molecular sieve and activated carbon may contain rich porous structures, which may physically adsorb a variety of gas molecules. The organic conjugated material containing acidic groups may achieve specific absorption of NH₃. The metal-organic framework material may achieve specific absorption of I₂. The porous absorption material may include any one or a combination of at least two of molecular sieve, activated carbon, organic conjugated material containing acidic groups, and metal-organic framework materials, which may fully absorb I₂ generated from the linear polarization layer 302 and NH₃ generated from the encapsulation layer 102 under high temperature and high humidity conditions from the aspects of physical adsorption and/or specific absorption, prevent the gas from corroding and damaging the internal structure of the display module, reduce or avoid the risk of failure of the polarizing component, solve the problems of poor display and poor touch, and make the display module have better display effect and touch effect.

In some embodiments of the present disclosure, the acidic group in the organic conjugated material containing acidic groups may include at least one of carboxylic acid group, phosphoric acid group, and sulfonic acid group. The organic conjugated structure in the organic conjugated material containing acidic groups may include C6-C60 aromatic structures, such as monocyclic or condensed aromatic structures of C6, C9, C10, C12, C14, C16, C18, C20, C22, C24, C26, C28, C30, C32, C34, C36, C38, C40, C42, C44, C46, C48, C50, C52, C54, C56, or C58, etc., exemplarily including but not limited to: at least one of benzene structure, biphenyl structure, naphthalene structure, anthracene structure, phenanthrene structure, triphenylene structure, pyrene structure and chrysene structure.

In the present disclosure, the connection mode and connection site of the acidic group and the organic conjugated structure in the organic conjugated material containing acidic groups are not limited, and the materials containing acidic groups and organic conjugated structures are suitable for the present disclosure, and may play a role in specifically absorbing NH₃.

For example, the organic conjugated material containing acidic groups may refer to the material types disclosed in the prior art, such as “Ammonia capture in porous organic polymers densely functionalized with Bronsted acid groups”, J F V Humbeck et al., Journal of the American Chemical Society, 2014, 136, 2432-2440.

In some embodiments of the present disclosure, the metal-organic framework material may be a metal-organic framework material containing electron-rich groups.

In one embodiment, the metal-organic framework material may include a zeolite imidazolate framework material (ZIF), and the metal ions may include transition metal ions, such as Co²⁺ and/or Zn²⁺, and the organic ligands may include any one or a combination of at least two of imidazole and imidazole derivatives (such as 2-methylimidazole Hmim, and benzimidazole bIm). For example, the metal-organic framework material may include ZIF-8 (an octahedral metal-organic framework composed of zinc and 2-methylimidazole).

In some embodiments of the present disclosure, the pore size of the activated carbon may be in a range of approximately 0.1 nm-50 nm, for example, it may be 0.5 nm, 1 nm, 2 nm, 5 nm, 8 nm, 10 nm, 12 nm, 15 nm, 18 nm, 20 nm, 22 nm, 25 nm, 28 nm, 30 nm, 32 nm, 35 nm, 38 nm, 40 nm, 42 nm, 45 nm or 48 nm, as well as specific point values between the above point values. Due to space limitations and for the sake of simplicity, the present disclosure no longer exhaustively lists the specific point values included in the range.

In some embodiments of the present disclosure, the pore size of the molecular sieve may be in a range of approximately 0.4 nm-10 nm, for example, it may be 0.5 nm, 0.8 nm, 1 nm, 1.5 nm, 2 nm, 2.5 nm, 3 nm, 3.5 nm, 4 nm, 4.5 nm, 5 nm, 5.5 nm, 6 nm, 6.5 nm, 7 nm, 7.5 nm, 8 nm, 8.5 nm, 9 nm or 9.5 nm, as well as specific point values between the above point values. Due to space limitations and for the sake of simplicity, the present disclosure no longer exhaustively lists the specific point values included in the range.

In some embodiments, the pore size of the organic conjugated material containing an acidic group may be in a range of approximately 0.1 nm-50 nm, for example, 0.5 nm, 1 nm, 2 nm, 5 nm, 8 nm, 10 nm, 12 nm, 15 nm, 18 nm, 20 nm, 22 nm, 25 nm, 28 nm, 30 nm, 32 nm, 35 nm, 38 nm, 40 nm, 42 nm, 45 nm or 48 nm, as well as specific point values between the above point values. Due to space limitations and for simplicity, the present disclosure no longer exhaustively lists the specific point values included in the range.

In some embodiments, the pore size of the metal-organic framework material may be in a range of approximately 0.1 nm-50 nm, for example, it may be 0.5 nm, 1 nm, 2 nm, 5 nm, 8 nm, 10 nm, 12 nm, 15 nm, 18 nm, 20 nm, 22 nm, 25 nm, 28 nm, 30 nm, 32 nm, 35 nm, 38 nm, 40 nm, 42 nm, 45 nm or 48 nm, as well as specific point values between the above point values. Due to space limitations and for the sake of simplicity, the present disclosure no longer exhaustively lists the specific point values included in the range.

In the present disclosure, the pore structure of the porous absorption material may be directional and/or random holes, and according to its morphology, it may be an independent hole type and/or a continuous hole type. The present disclosure does not specifically limit the arrangement direction and morphology of the holes. The porous absorption material contains a rich pore structure. By optimizing the pore structure in the material, it may form a more effective and sufficient adsorption of gases such as I₂ and NH₃, block the invasion of water vapor, and prevent the gas from corroding and damaging the internal structure of the display module.

In this disclosure, the term “pore size” refers to the size of the pores in the porous absorption material, which may be understood as the equivalent diameter of the pores.

In some embodiments of the present disclosure, the porous absorption material may be a micron-scale granular material, which may be uniformly dispersed in the matrix resin to form the absorption layer.

In some embodiments of the present disclosure, the particle size of the porous absorption material may be in a range of approximately 0.01 μm-40 μm, for example, it may be 0.1 μm, 0.2 μm, 0.5 μm, 0.8 μm, 1 μm, 2 μm, 3 μm, 5 μm, 8 μm, 10 μm, 12 μm, 15 μm, 18 μm, 20 μm, 22 μm, 25 μm, 28 μm, 30 μm, 32 μm, 35 μm or 38 μm, as well as specific point values between the above point values. Due to space limitations and for the sake of simplicity, the present disclosure no longer exhaustively lists the specific point values included in the range, and the optional range is 0.1 μm-20 μm.

In some embodiments of the present disclosure, the porous absorbent material may include an organic conjugated material containing an acidic group, a metal organic framework material and optionally a combination of molecular sieves.

In the present disclosure, the organic conjugated material containing acidic groups may have a specific absorption effect on NH₃ generated by the encapsulation layer, the metal-organic framework material specifically absorbs I₂ generated by the linear deflection layer, and the molecular sieve may have a good physical adsorption effect on a variety of gases. Through the compounding of the organic conjugated material containing acidic groups, the metal-organic framework material and the optional molecular sieve, the absorption layer may play a role in both specific absorption and physical adsorption, may fully absorb the gas escaping under high temperature and high humidity conditions, and effectively block water vapor, comprehensively prevent the gas from corroding and invading the internal structure of the display module, and more thoroughly solve the problems of poor display and poor touch caused by failure. Accordingly, the display module may have better display effect and touch effect.

In some embodiments of the present disclosure, the mass ratio of the organic conjugated material containing acidic groups to the metal-organic framework material in the porous absorption material may be in a range of approximately (1-2):1, for example, it may be 1.1:1, 1.2:1, 1.3:1, 1.4:1, 1.5:1, 1.6:1, 1.7:1, 1.8:1, or 1.9:1, etc.

In some embodiments, the mass percentage of molecular sieve in the porous absorption material may be ≤50%, for example, it may be 0, 1%, 2%, 5%, 8%, 10%, 12%, 15%, 18%, 20%, 22%, 25%, 28%, 30%, 32%, 35%, 38%, 40%, 42%, 45%, or 48%, or specific point values between the above point values. Due to space limitations and for simplicity, the present disclosure no longer exhaustively lists the specific point values included in the range, and further optional may be 2-40%.

The present disclosure may optimize the type and proportion of porous absorption materials in the absorption layer such that the mass ratio of organic conjugated materials containing acidic groups to metal-organic framework materials may be in a range of approximately (1-2):1, and the mass content of molecular sieves in the porous absorption materials may be in a range of approximately 2-40%. The three types of materials may cooperate with each other to more fully specifically absorb and physically adsorb gases such as NH₃ and I₂, and enable the absorption layer to block water vapor invasion, avoid gas corrosion and damage to the internal structure of the display module, and comprehensively improve the display touch effect and reliability of the display module.

In some embodiments of the present disclosure, the matrix resin may include polyacrylate. In some embodiments of the present disclosure, the mass ratio of the matrix resin to the porous absorption material in the absorption layer may be 1:(0.2-1), for example, it may be 1:0.3, 1:0.4, 1:0.5, 1:0.6, 1:0.7, 1:0.8, or 1:0.9.

In the present disclosure, the matrix resin in the absorption layer may disperse the porous absorption material and provide cohesion and adhesion. By further optimizing the mass ratio of the matrix resin to the porous absorption material to 1:(0.2-1), the absorption layer may more stably and reliably absorb gas and block water vapor intrusion, thereby improving the display effect and touch effect of the display module. If the amount of the matrix resin is too low, the bonding force between the absorption layer and the display panel and the polarizing component may be reduced, affecting the long-term stability of the absorption layer. If the amount of the matrix resin is too high, it may affect the absorption effect of the absorption layer on gas.

In some embodiments of the present disclosure, the display panel may include a display area and a non-display area surrounding the display area. The projection of the absorption layer on the display panel may be located in the non-display area.

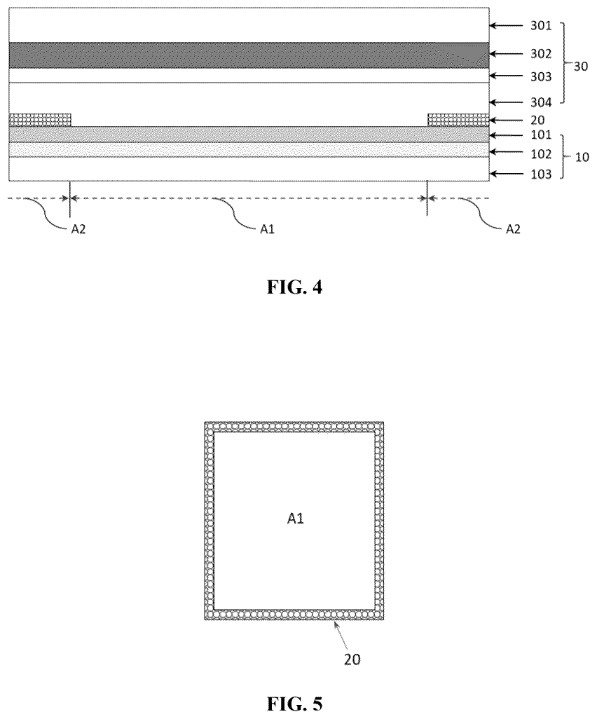

FIG. 4 is a structural schematic diagram of another exemplary display module according to various embodiments of the present disclosure. FIG. 5 is a top view of the display module shown in FIG. 4. As shown in FIG. 4 and FIG. 5, the display module may include a display panel 10, an absorption layer 20 and a polarizing component 30. The display panel 10 may include a touch layer 101, an encapsulation layer 102 and a light-emitting layer 103 arranged in sequence. The touch layer 101 may be located on a side of the display panel adjacent to the polarizing component 30. The polarizing component 30 may include a protective layer 301, a linear polarization layer 302, a wave plate layer 303 and an adhesive layer 304 arranged in sequence. The adhesive layer 304 may be located on a side of the polarizing component 30 adjacent to the display panel 10. The display panel 10 may include a display area A1 and a non-display area A2 surrounding the display area A1. As shown in FIG. 5, the projection of the absorption layer 20 on the display panel 10 may be located in the non-display area A2. Therefore, under the premise that the absorption layer does not affect the display effect of the display module, it may fully absorb I₂, NH₃ and other gases escaping from the polarizing component (the linear polarization layer 302) and the display panel (the encapsulation layer 102) under high temperature and high humidity conditions, preventing the gas from corroding and damaging the internal structure of the display panel and the polarizing component, and effectively reducing the corrosion of the metal touch layer that begins at the edge of the display module under high temperature and high humidity conditions.

In some embodiments of the present disclosure, the width of the absorption layer 20 may be in a range of approximately 1.5-5 mm, for example, it may be 1.8 mm, 2 mm, 2.2 mm, 2.5 mm, 2.8 mm, 3 mm, 3.2 mm, 3.5 mm, 3.8 mm, 4 mm, 4.2 mm, 4.5 mm, or 4.8 mm, as well as specific point values between the above point values. Due to space limitations and for the sake of simplicity, the present disclosure no longer exhaustively lists the specific point values included in the range.

The present disclosure may further design the absorption layer 20 to have a width of 1.5-5 mm, such that, on the one hand, it may fully absorb I₂, NH₃ and other gases escaping from the polarizing component (the linear polarization layer 302) and the display panel (the encapsulation layer 102) under the high temperature and high humidity conditions, and block water vapor, effectively preventing the gas from corroding and damaging the internal structure of the display panel and the polarizing component, and avoiding the risk of poor display and touch failure; on the other hand, the width of the absorption layer 20 may be relatively narrow, which may not have an adverse effect on the display area and its display effect.

In some embodiments of the present disclosure, the thickness of the absorption layer 20 may be L1, the thickness of the adhesive layer 304 may be L2, and L1/L2≤0.3, for example, L1/L2 may be 0.05, 0.06, 0.08, 0.1, 0.12, 0.15, 0.18, 0.2, 0.22, 0.25 or 0.28, or specific point values between the above point values. Due to space limitations and for simplicity, the present disclosure no longer exhaustively lists the specific point values included in the range.

The present disclosure may further design the thickness ratio of the absorption layer 20 to the adhesive layer 304 in the polarizing assembly to be L1/L2≤0.3, such that the thickness of the absorption layer 20 may fully meet the requirements of absorbing the I₂ and NH₃ gases escaping from the polarizing component (the linear polarization layer 302) and the display panel (the encapsulation layer 102) under high temperature and high humidity conditions, and effectively block water vapor to prevent the gas from corroding and damaging the internal structure of the display module, especially effectively reducing the corrosion of the metal touch layer that begins at the edge of the display module under high temperature and high humidity conditions, avoiding the risk of poor display and touch failure. At the same time, the absorption layer 20 may have a negligible effect on the overall thickness of the display module such that the display module may remain thin and portable.

In some embodiments of the present disclosure, the thickness of the polarizing component 30 may be 40 μm-150 μm, for example, 50 μm, 60 μm, 70 μm, 80 μm, 90 μm, 100 μm, 110 μm, 120 μm, 130 μm, or 140 μm, as well as specific point values between the above point values. Due to space limitations and for the sake of simplicity, the present disclosure no longer exhaustively lists the specific point values included in the range.

In some optional embodiments of the present disclosure, the display module may be a foldable display module. Compared with non-foldable display modules, foldable display modules with flexible characteristics are more likely to have polarizer failure and fading, display abnormality, reduced touch sensitivity, and even touch failure under elevated temperature and high humidity conditions. The present disclosure may effectively block water vapor through the design of the absorption layer, fully absorb the I₂ and NH₃ gases escaping from the polarizing component (the linear polarizing layer 302) and the display panel (the encapsulation layer 102) under high temperature and high humidity conditions, prevent the gas from corroding and damaging the internal structure of the folding display module, and especially effectively reduce the corrosion of the metal touch layer starting from the edge of the folding display module under high temperature and high humidity conditions, thereby significantly improving the yield, reliability and quality of the foldable display module.

In some embodiments of the present disclosure, the thickness of the polarizing component in the foldable display module may be in a range of approximately 40 μm-80 μm, for example, it may be 42 μm, 45 μm, 48 μm, 50 μm, 52 μm, 55 μm, 58 μm, 60 μm, 62 μm, 65 μm, 68 μm, 70 μm, 72 μm, 75 μm, or 78 μm, as well as specific point values between the above point values. Due to space limitations and for the sake of simplicity, the present disclosure no longer exhaustively lists the specific point values included in the range.

In some embodiments, the reliability of the display module and foldable display module provided in the above embodiments under high temperature and high humidity conditions is evaluated, specifically, after the preset time of double 85 (85° C., humidity 85% RH) or 6090 test, the edge structure of the display module and foldable display module is tested by scanning electron microscope (SEM) and X-ray energy spectrometer (EDX). Due to the design of the absorption layer, the display module and foldable display module of the present disclosure have excellent reliability under elevated temperature and high humidity environments, and there are no problems of corrosion of the edge of the metal touch layer, failure of the polarizing component, poor display and touch.

In some optional embodiments of the present disclosure, the fabrication method of the display module may include:
providing an absorption adhesive including a combination of a prepolymer and a porous absorption material; and
applying the absorption adhesive between the display panel and the polarizing component, curing to form an absorption layer, and obtaining the display module.

In one embodiment, the prepolymer may include an acrylate prepolymer, which may be cured to obtain a polyacrylate as a matrix resin of the absorption layer. The present disclosure does not specifically limit the specific type of acrylate prepolymer, and any acrylate prepolymer containing unsaturated double-bond functional groups known in the art may be applied to the present disclosure.

In one embodiment, the absorbent adhesive may also include any one of an initiator, a crosslinker, a diluent, and an auxiliary agent, or a combination of at least two of them.

In one embodiment, the initiator may include a photoinitiator such that the absorbent adhesive may be cured under ultraviolet irradiation conditions to obtain the absorbent layer.

In one embodiment, the photoinitiator may include any one of an alkyl phenone compound, a benzophenone compound, a benzyl compound, a benzoin compound, and an acylphosphine oxide, or a combination of at least two of them.

In one embodiment, the crosslinker may include an acrylate compound with a functionality ≥2 (for example, a functionality of 2, 3, 4, 5, 6, etc.), which may be cured with the acrylate prepolymer in the presence of an initiator to obtain a polyacrylate as the matrix resin of the absorbent layer.

In one embodiment, the auxiliary agent may include any one of a coupling agent (such as a silane coupling agent, or a titanate coupling agent, etc.), a dispersant, a leveling agent, a defoaming agent, an antioxidant, a viscosity modifier, and a stabilizer, or a combination of at least two thereof.

The present disclosure also provides a display device. The display device may include any one of the display modules provided by the embodiments of the present disclosure.

Because the display device may adopt the above display module, the display device may also have the technical effect of the display module described in the above embodiments. It should be noted that the display device provided by the embodiments of the present disclosure may also include other circuits and devices for supporting the normal operation of the display device. The display device exemplarily includes but is not limited to any one of a mobile phone, a tablet computer, an electronic photo frame, and an electronic paper.

The present invention may include the following beneficial effects.

In the display module provided by the present disclosure, by setting an absorption layer containing porous absorption material between the display panel and the polarizing component, it may fully absorb various gases escaping from the display module under harsh conditions such as high temperature and high humidity, prevent the gas from corroding the internal structure of the display panel and the polarizing component, and block the invading water vapor, reduce or avoid the failure risk of the polarizer, and effectively solve the display and touch problems caused by the failure of the polarizer. Accordingly, the display module and the display device containing it may have better display and touch effects, higher reliability, and the quality and yield of the product may be improved.

The present disclosure illustrates the display module of the present disclosure and the display device containing the same through the above embodiments, but the present disclosure is not limited to the above process steps, that is, it does not mean that the present disclosure must rely on the above process steps to be implemented. The technicians in the relevant technical field should understand that any improvement of the present disclosure, the equivalent replacement of the raw materials selected by the present disclosure, the addition of auxiliary components, the selection of specific methods, etc., all fall within the scope of protection and disclosure of the present disclosure.

What is claimed is:

1. A display module, comprising:
a display panel;
a polarizing component; and
an absorption layer disposed between the display panel and the polarizing component,
wherein the absorption layer includes a combination of a matrix resin and a porous absorption material.

2. The display module according to claim 1, wherein the display panel comprises:
a light-emitting layer;
a touch layer; and
an encapsulation layer disposed between the light-emitting layer and the touch layer,
wherein the touch layer is located on a side of the display panel adjacent to the polarizing component.

3. The display module according to claim 2, wherein:
the encapsulation layer includes silicon nitride and silicon oxide.

4. The display module according to claim 2, wherein the touch layer comprises:
a metal touch layer.

5. The display module according to claim 1, wherein:
the polarizing component includes an adhesive layer, a wave plate layer, a linear polarization layer and a protective layer are arranged in sequence; and
the adhesive layer is located on a side of the polarizing component adjacent to the display panel.

6. The display module according to claim 5, wherein:
the linear polarization layer includes an iodine-based polarizer.

7. The display module according to claim 1, wherein:
the porous absorption material includes molecular sieve, activated carbon, organic conjugated material containing an acidic group, metal-organic framework material, or a combination thereof.

8. The display module according to claim 7, wherein:
the acidic group in the organic conjugated material containing acidic group includes at least one of carboxylic acid group, phosphoric acid group and sulfonic acid group; and/or
the organic conjugated structure in the organic conjugated material containing the acidic group includes at least one of benzene structure, biphenyl structure, naphthalene structure, anthracene structure, phenanthrene structure, triphenylene structure, pyrene structure and chrysene structure.

9. The display module according to claim 7, wherein:
the metal-organic framework material is a metal-organic framework material containing an electron-rich group.

10. The display module according to claim 7, wherein:
a pore size of the molecular sieve is in a range of approximately 0.4 nm-10 nm; and/or
a pore size of the organic conjugated material containing the acidic group is in a range of approximately 0.1 nm-50 nm; and/or
a pore size of the metal-organic framework material is in a range of approximately 0.1 nm-50 nm.

11. The display module according to claim 7, wherein:
the porous absorption material includes a combination of an organic conjugated material containing an acidic group, a metal-organic framework material and a molecular sieve.

12. The display module according to claim 11, wherein:
a mass ratio of the organic conjugated material containing the acidic group to the metal-organic framework material in the porous absorption material is in a range of approximately (1-2):1; and/or
a mass percentage of the molecular sieve in the porous absorption material is ≤50%.

13. The display module according to claim 1, wherein:
the matrix resin includes polyacrylate.

14. The display module according to claim 1, wherein:
a mass ratio of the matrix resin to the porous absorption material in the absorption layer is in a range of approximately 1:(0.2-1).

15. The display module according to claim 1, wherein the display panel comprises:
a display area; and
a non-display areas surrounding the display area,
wherein a projection of the absorption layer on the display panel is in the non-display area.

16. The display module according to claim 15, wherein:
a width of the absorption layer is in a range of approximately 1.5 mm-5 mm.

17. The display module according to claim 5, wherein:
a thickness of the absorption layer is L1;
a thickness of the adhesive layer L2; and
L1/L2≤0.3.

18. The display module according to claim 1, wherein:
a thickness of the polarizing component is in a range of approximately 40 μm-150 μm.

19. The display module according to claim 1, wherein:
the display module is a foldable display module; and
a thickness of the polarizing component in the foldable display module is in a range of approximately 40 μm-80 μm.

20. A display device, comprising:
a display module including:
a display panel;
a polarizing component; and
an absorption layer disposed between the display panel and the polarizing component,
wherein the absorption layer includes a combination of a matrix resin and a porous absorption material.
